(19) United States
(12) Patent Application Publication
(10) Pub. No.: US 2026/0177694 A1
(43) Pub. Date: Jun. 25, 2026

(54) DIRECTION OF TRAVEL-DEPENDENT SETTING OF A DETECTION AREA OF ULTRASONIC SENSOR ARRAYS

(71) Applicant: Robert Bosch GmbH, Stuttgart (DE)

(72) Inventors: Matthias Boecker, Saarbrücken (DE); Michael Schumann, Stuttgart (DE)

(21) Appl. No.: 18/711,677

(22) PCT Filed: Nov. 17, 2022
(86) PCT No.: PCT/EP2022/082237

§ 371 Date: May 20, 2024

(30) Foreign Application Priority Data
Dec. 7, 2021 (DE) 10 2021 213 905.1

(51) Int. Cl. G01S 15/931; G01S 7/521; G01S 15/87; G01S 15/89

(52) U.S. Cl. CPC G01S 15/931; G01S 7/521; G01S 15/87; G01S 15/8925

(57) ABSTRACT

A method for adjusting a detection area of at least one ultrasonic sensor array of a vehicle using a controller. Measurement data are received and a direction of travel is ascertained. Control signals for controlling at least two transducer elements of at least one ultrasonic sensor array are generated. A phase shift between the ultrasonic waves transmitted by the transducer elements and/or a phase shift between the ultrasonic waves received by the transducer elements is set using the control signals, which phase shift is adjusted to the direction of travel of the vehicle. A controller, a computer program, and a machine-readable storage medium are also described.

### FIELD

The present invention relates to a method for adjusting a detection area of at least one ultrasonic sensor array of a vehicle, and to a controller, a computer program, and a machine-readable storage medium.

### BACKGROUND INFORMATION

Ultrasonic sensors are typically used to monitor the immediate vehicle environment. The ultrasonic sensors have an optimal range of approximately 5 m, wherein each ultrasonic sensor acts as a single source. The radiation angle of the sound lobe or of the detection area of common ultrasonic sensors is basically not changeable. Reliably functioning ultrasound-based distance measurement and object recognition requires redundant or overlapping measurement of obstacles with a plurality of ultrasonic sensors. However, such an overlap of detection areas of a plurality of ultrasonic sensors is not given, in particular when driving through curves.

U.S. Pat. No. 5,531,117 A describes controlling a phase shift in a phased array in order to spread a resulting ultrasound cone to any point. As a result, the environment to be examined can be scanned.

German Patent Application No. DE 10 2005 024 052 A1 describes an ultrasonic system in which a control of the total viewing angle on the basis of data from other systems or operating modes, for example depending on the steering angle, is used.

### SUMMARY

An object of the present invention is to provide a method by means of which an ultrasound-based measurement is dynamically adjustable to different traffic situations.

This object may be achieved by the respective subject matter of the present. Advantageous embodiments of the present invention are disclosed herein.

According to one aspect of the present invention, a method for adjusting a detection area of at least one ultrasonic sensor array of a vehicle is provided. The method can preferably be carried out by a controller alone or in conjunction with corresponding onboard sensors.

According to an example embodiment of the present invention, in a step, measurement data are received and a direction of travel is ascertained by evaluating the measurement data. Control signals for controlling at least two transducer elements of at least one ultrasonic sensor array are subsequently generated.

In so doing, a phase shift between the ultrasonic waves transmitted by the transducer elements and/or a phase shift between the ultrasonic waves received by the transducer elements is set by means of the control signals, which phase shift is adjusted to the direction of travel of the vehicle.

By means of the method, onboard ultrasonic sensor arrays can swivel their detection area horizontally and/or vertically such that the detection area, or field of view, is aligned depending on a travel route envelope of the vehicle. In this case, detection areas of a plurality of ultrasonic sensor arrays can be directed toward the expected travel route envelope or swiveled beyond the travel route envelope.

The travel route envelope here represents a virtual area, which is expected to be exceeded or superposed by the vehicle contour when the vehicle drives through curves or straight ahead.

The method makes it possible to control ultrasonic sensor arrays intelligently and dynamically with respect to the phase shift of the respective transducer elements. By means of the set phase shift in the generation or reception of ultrasonic waves by the transducer elements, a direction of the detection area, which consists at least of a main lobe, can be set or changed. By adjusting the phase shift, the detection area can thus be swiveled or rotated in order, for example, to dynamically follow the direction of travel of the vehicle. This can increase the localization accuracy and the classification in the object recognition. In particular, the resulting measurement data of the ultrasonic sensor arrays can be used alone or in a supporting manner for object recognition.

For example, the method can improve control of automatic braking. In particular, the higher number of relevant sensors that are “focusable” on an area relevant to braking can make better plausibility of the individual results possible and thereby result in a reduction in misinterpretations.

In addition, the method can be used in the parking space search, in which a specific, different control of the individual ultrasonic sensor arrays makes better characterization of a parking space possible.

According to a further aspect of the present invention, a controller is provided, wherein the controller is configured to perform the method of the present invention. The controller can, for example, be an onboard controller, an offboard controller, or an offboard server unit, such as a cloud system. Preferably, at least one memory is provided, which is connectable to the controller or integrated in the controller in order to store data at least temporarily.

According to an example embodiment of the present invention, the controller can preferably be connected in a data-transmitting manner to at least two transducer elements of at least one ultrasonic sensor array. In particular, the controller can individually control the transducer elements for transmitting and/or receiving sonic waves.

In addition, according to one aspect of the present invention, a computer program is provided, which comprises instructions that, when executed by a computer or controller, cause the computer or controller to perform the method according to the present invention. According to another aspect of the present invention, a machine-readable storage medium is provided, on which the computer program according to the present invention is stored.

The vehicle can in this case be operated in an assisted, partially automated, highly automated, and/or fully automated, or driverless, manner in accordance with the BASt standard.

According to an example embodiment of the present invention, the ultrasonic sensor array of the sensor assembly comprises at least two transducer elements spaced apart from one another in the vertical direction and/or in the horizontal direction, wherein the transducer elements and the at least one ultrasonic sensor can be controlled and/or read by a controller electrically connected to the transducer elements.

The respective transducer elements are designed as partial sensors of the ultrasonic sensor array and can be controlled and evaluated independently of one another by the controller. In particular, the generated sonic waves of the transducer elements can interfere with one another, as a result of which the major axis of the emitted sonic echoes is tilted or deflected in relation to the surface normal.

In particular, by controlling the transducer elements in a phase-shifted manner, for example between vertically offset rows of elements, the major axis of the vertical sonic radiation can be tilted in relation to the major sensor membrane axis.

According to an example embodiment of the present invention, preferably, the transducer elements that are excited by membrane oscillations and/or cylinder oscillations to generate and receive sonic waves are arranged on a common plane, on the basis of which the surface normal is defined.

The at least one ultrasonic sensor array can preferably be produced in MEMS technology and, for example, be designed as a so-called piezoelectric micromachined ultrasonic transducer (PMUT sensor). The transducer elements can be designed as membranes or as vibrating pistons or as combined membrane-piston assemblies in order to generate and/or receive acoustic pulses or sonic waves.

In one embodiment example of the present invention, the measurement data for ascertaining the direction of travel are received from a unit designed as a parking assistance system, a steering angle sensor, a GNSS sensor, a trajectory planning, and/or from a unit designed as a navigation system. By this measure, the direction of travel and, in addition, an expected travel route envelope of the vehicle can be determined on the basis of a multitude of measurement data. In this case, the data from a camera system of a parking assistant, data from a GNSS-based navigation system, or measurement data from different onboard sensors can be used.

According to a further embodiment of the present invention, the phase shift between the ultrasonic waves transmitted by the transducer elements is set such that a detection area of the at least one ultrasonic sensor array overlaps a travel route envelope of the vehicle. As a result, a plurality of ultrasonic sensor arrays, or only one ultrasonic sensor array of a plurality of existing ultrasonic sensor arrays, can be set with respect to the alignment of the detection area by means of the control signals such that the travel route envelope is overlapped with detection areas of a plurality of ultrasonic sensor arrays.

Alternatively, or additionally, a combination of static or bulk ultrasonic sensors and ultrasonic sensor arrays can be used.

According to a further embodiment example of the present invention, a travel route envelope of the vehicle is overlapped by the detection area of at least one ultrasonic sensor array in the direction of travel of the vehicle and/or a travel route envelope of the vehicle is overlapped by the detection area of at least one ultrasonic sensor array in the direction opposite the direction of travel of the vehicle. By this measure, ultrasonic sensor arrays can be controlled in any direction in the vehicle environment with respect to horizontal and/or vertical alignment of the detection area.

For example, when driving onto an incline in the front area of the vehicle, the detection area can be raised or swiveled away from the ground by the ultrasonic sensor arrays and lowered toward the ground in the rear area of the vehicle in order to make optimal recognition of obstacles even near the ground possible.

According to a further embodiment of the present invention, a phase shift between the generated ultrasonic waves of at least two transducer elements arranged offset from one another along a transverse direction and/or along a height direction is set by means of the generated control signals, wherein the transducer elements have a distance to one another in the transverse direction and/or in the height direction of at least half the wavelength of the generated ultrasonic waves. By arranging the transducer elements at a distance of substantially half a wavelength of the generated ultrasonic waves, the influences of side lobes on the generated ultrasonic waves can be minimized.

According to a further embodiment example of the present invention, the phase shift of transducer elements of at least two ultrasonic sensor arrays is set by means of the generated control signals such that the detection areas of the at least two ultrasonic sensor arrays overlap in the area of the travel route envelope of the vehicle. Focusing a plurality of detection areas on the expected travel route envelope can thereby be realized. Such focusing of the detection areas can be made possible by rotating or swiveling a detection area of one ultrasonic sensor array or of a plurality of ultrasonic sensor arrays.

According to a further embodiment of the present invention, when the vehicle drives straight ahead, a detection area of at least one first ultrasonic sensor array and a detection area of at least one second ultrasonic sensor array are concentrated toward an axis of symmetry of the vehicle or are directed away from the axis of symmetry of the vehicle by a positive phase shift and by a negative phase shift, respectively. With the help of this measure, a plurality of ultrasonic sensor arrays arranged on the vehicle can be controlled by means of the control signals or control commands such that a “cross-eyed view” of the corresponding sensor assembly of a plurality of ultrasonic sensor arrays is realized, in which the detection areas of the ultrasonic sensor arrays are rotated or deflected toward the vehicle sides. This increases the resulting detection area of all ultrasonic sensor arrays.

Alternatively, concentrating or focusing the detection areas toward the axis of symmetry of the vehicle is achieved. The resulting detection area of all ultrasonic sensor arrays is thus reduced.

Preferably, according to an example embodiment of the present invention, the axis of symmetry of the vehicle is an axis that is directed in the longitudinal direction or in the direction of travel and passes through a center of the vehicle, in particular between a driver seat and a passenger seat.

In addition, two operating modes can be realized when positioning the outer lateral ultrasonic sensor arrays. In particular, an operating mode for free maneuvering, or a so-called PAS mode, and an operating mode for parking space searching can be implemented. In the free maneuvering operating mode, an overlap of detection areas of as many ultrasonic sensor arrays as possible is set. In this case, ultrasonic sensor arrays arranged externally on the vehicle sides are rotated toward the axis of symmetry so that as many cross echoes as possible of the neighboring sensors can be received.

In contrast, in the park space searching operating mode, the detection area of at least one ultrasonic sensor array can be set perpendicularly to the driving movement or adjusted to the direction of travel. By this measure, front and rear flanks of vehicles delimiting parking spaces can be equally illuminated.

In addition, a reception sensitivity can be specifically increased by beam steering in the high angular ranges in the event a parking space is detected. As a consequence, additional echo signals are obtained, which can be used via trilateration to improve the localization and classification of the vehicle corner.

In this configuration, reception side lobes can be created by means of the high steering angles of the detection area in particular in the front area of the vehicle, i.e., ultrasonic echoes from these areas could thus be mistakenly interpreted as side echoes and distort the signal evaluation. However, only echoes with a distance of less than the typical passing distance from lateral objects, i.e., approx. 2-3 m, are relevant here. At higher driving speeds (typically more than 10 km/h), ground echoes occur here as a real source. It is therefore advantageous if the reception characteristic is also directed vertically upward or away from the ground in addition to the lateral “cross-eyed view.” This could be achieved, for example, by an ultrasonic sensor array with a 2×2 arrangement of transducer elements, in which two transducer elements are spaced apart from one another along a transverse direction and two transducer elements are spaced apart from one another along a vertical direction.

According to a further embodiment example of the present invention, the detection area of the at least one ultrasonic sensor array is swiveled according to a steering angle of the vehicle onto the resulting travel route envelope of the vehicle or beyond the travel route envelope in the direction of the steering angle. As a result, the detection area of at least one ultrasonic sensor array can be swiveled or its alignment can be changed such that even an area “behind” the travel route envelope is covered.

According to a further embodiment of the present invention, the phase shift of at least one ultrasonic sensor array of a set of a plurality of ultrasonic sensor arrays is set by means of the generated control signals. The other ultrasonic sensor arrays are not changed with respect to their phase shift. The effort required to control the respective ultrasonic sensor arrays can thus be reduced since only a portion of the available ultrasonic sensor arrays must be controlled by the controller.

Advantageously, regular ultrasonic sensors or bulk ultrasonic sensors can be used instead of non-controlled ultrasonic sensor arrays.

According to a further embodiment example of the present invention, control signals are generated in order to apply different phase shifts to at least two ultrasonic sensor arrays. Depending on the position of the ultrasonic sensor arrays on the vehicle, the set phase shifts may have different magnitudes. For example, when driving through curves, a lower phase shift can be applied to an internal ultrasonic sensor array than to an external ultrasonic sensor array.

According to a further embodiment of the present invention, a phase shift between the ultrasonic waves transmitted by the transducer elements that continuously changes along an angular range and is dynamically adjusted to the direction of travel of the vehicle is set by means of the control signals. By this measure, an angular range along which the phase shift is varied can be set depending on the direction of travel of the vehicle. This makes scanning of the angular range possible. For example, by controlling the ultrasonic sensor arrays on the vehicle, a scanning area can be scanned first to the left and then to the right.

According to a further embodiment example of the present invention, an alternating operation is carried out by means of the control signals. In this case, the at least one phase shift between the ultrasonic waves transmitted and/or received by the transducer elements is activated and deactivated. In the case of a deactivated phase shift, a phase shift of 0° is set or no phase shift is present. Dynamic beam steering can thus also be realized in alternation with a normal operation. Switching between the respective operating modes can, for example, occur as needed or at predefined time intervals.

Preferred embodiment examples of the present invention are described in more detail below, with reference to highly simplified schematic illustrations.

### BRIEF DESCRIPTION OF THE DRAWINGS

FIGS. 1-3 show schematic plan views of a rear area of a vehicle with visualized phase shift and a resulting detection area according to one example embodiment of the present invention.

FIG. 4 shows schematic plan views of a rear area of a vehicle with an adjusted phase angle when driving straight ahead and when driving through curves, according to one example embodiment of the present invention.

FIG. 5 shows a schematic plan view of a rear area of a vehicle with detection areas swiveled away from an axis of symmetry of the vehicle, according to one example embodiment of the present invention.

FIG. 6 shows a schematic flowchart for illustrating a method according to an example embodiment of the present invention.

### DETAILED DESCRIPTION OF EXAMPLE EMBODIMENTS

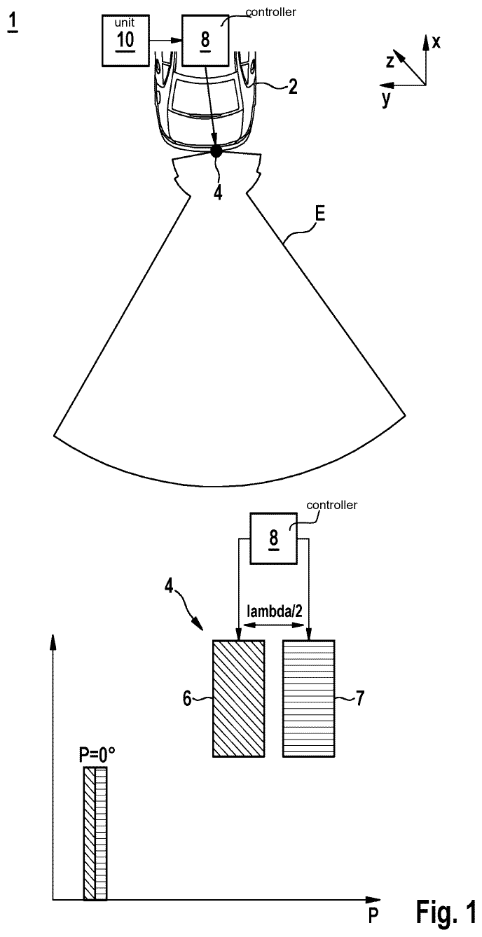

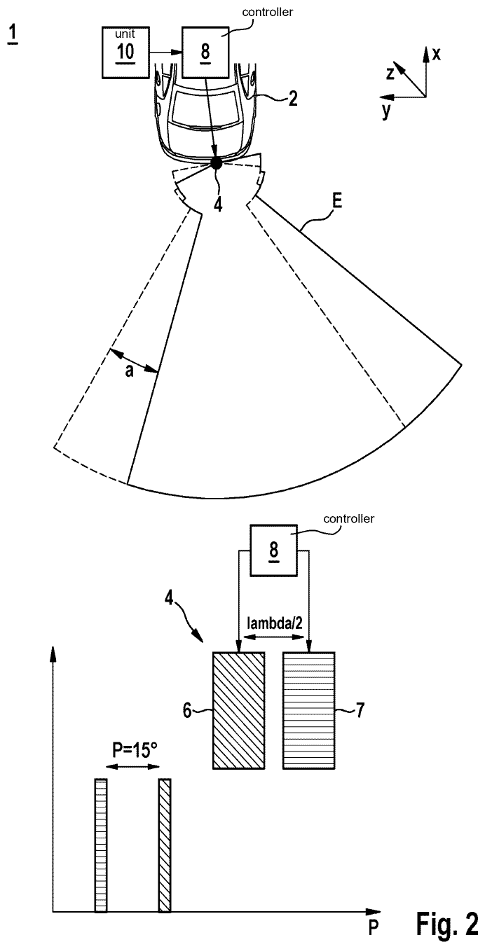

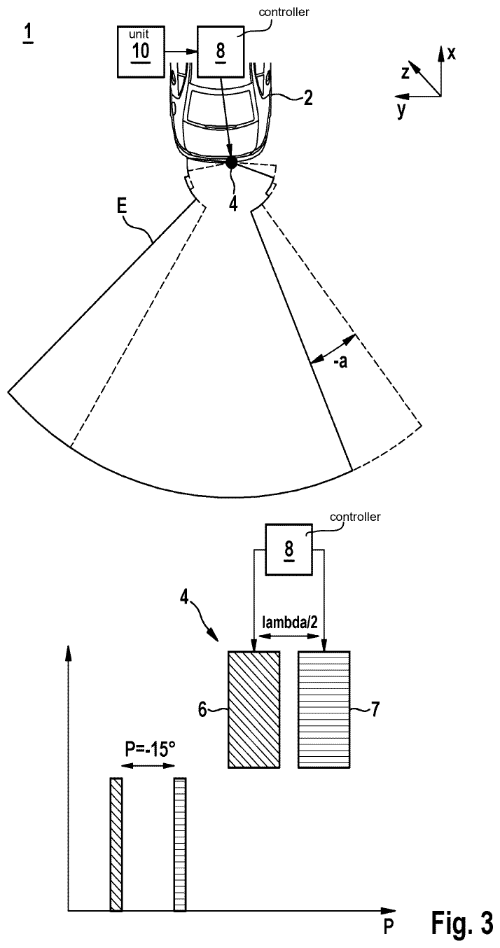

FIG. 1, FIG. 2, and FIG. 3 show schematic plan views of vehicle arrangement 1, which illustrate a rear area of a vehicle 2 with visualized phase shift P and a resulting detection area E behind the vehicle 2 according to embodiments of the present invention. In particular, the principle of horizontal beam steering is illustrated by way of example.

The vehicle 2 comprises one ultrasonic sensor array 4 by way of example. Any number of ultrasonic sensor arrays 4 can be used, which may be arranged symmetrically or asymmetrically along a contour of the vehicle 2. In addition, the vehicle 2 comprises a controller 8.

The at least one ultrasonic sensor array can also be arranged analogously in a front area and/or in at least one side area of the vehicle 2.

The ultrasonic sensor array 4 of the vehicle arrangement 1 comprises at least two transducer elements 6, 7 spaced apart from one another in the vertical direction z and/or in the transverse direction y and/or in the longitudinal direction x, wherein the transducer elements 6, 7 can be controlled and/or read by a controller 8 electrically connected to the transducer elements 6, 7. The controller 8 can generate control signals or control commands configured to cause the transducer elements 6, 7 individually with a phase shift P or without a phase shift P to transmit and/or receive ultrasonic waves. Along the transverse direction y, the two transducer elements 6, 7 have a distance to one another that corresponds to half a wavelength or lambda/2 of the generated ultrasonic waves.

By way of example, two transducer elements 6, 7 are shown in the area of the diagram in order to illustrate the relationship between the control of the transducer elements 6, 7 and a resulting change in the detection area E.

FIG. 1 shows a vehicle arrangement 1 in which no phase shift P=0° between the generated ultrasonic waves of the transducer elements 6, 7 is set by means of the generated control commands of the controller 8. As a result, the generated ultrasonic waves propagate perpendicularly to the sensor plane or a membrane plane of the transducer elements 6, 7 in the direction opposite the direction of travel. The diagram shows the corresponding ultrasonic pulses of the respective transducer elements 6, 7 with corresponding hatching. In this case, the transmitted ultrasonic pulses in the diagram illustrate that no phase shift P is set.

FIG. 2 shows an embodiment example of a vehicle arrangement 1 in which the controller 8 generates control commands that set a phase shift P of +15°. In this case, for example, a second transducer element 7 is controlled with a delay in relation to a first transducer element 6 in order to realize the phase shift P. The set phase shift P results in a rotation of the detection area E by a horizontal angle a. Analogously, FIG. 3 illustrates an embodiment example in which a phase shift P of −15° is set by means of corresponding control commands of the controller 8. The detection area E of the ultrasonic sensor array 4 is thus swiveled by an angle −a.

Depending on the direction of travel of the vehicle 2, it is possible that side areas are not sufficiently covered by conventional ultrasonic sensors, since their detection area is static. As a result, the localization accuracy of objects decreases. A particular significance of this fact comes into play when the vehicle 2 performs a curved movement, for example when parking backward. While multiple coverage of objects is generally present when driving straight backward, and it is therefore possible to detect an object very exactly, as described, the possibility of localizing objects when driving through curves is reduced significantly and lower redundancy is accordingly also present. In addition to localization accuracy, object classification (typically two classes: relevant to braking and warning or can be driven over) is an essential aspect for an ultrasonic system. Due to the lack of coverage in the edge area or side area, the object data set underlying the classification is significantly smaller than in the central area or in the area of an axis of symmetry S, as a result of which the classification is significantly restricted. A consequence thereof is a late correct classification, which can be referred to as a late initial detection time (in the two-class classification). This is particularly relevant to scenarios with objects laterally entering a travel route envelope F, for example pedestrians or cyclists.

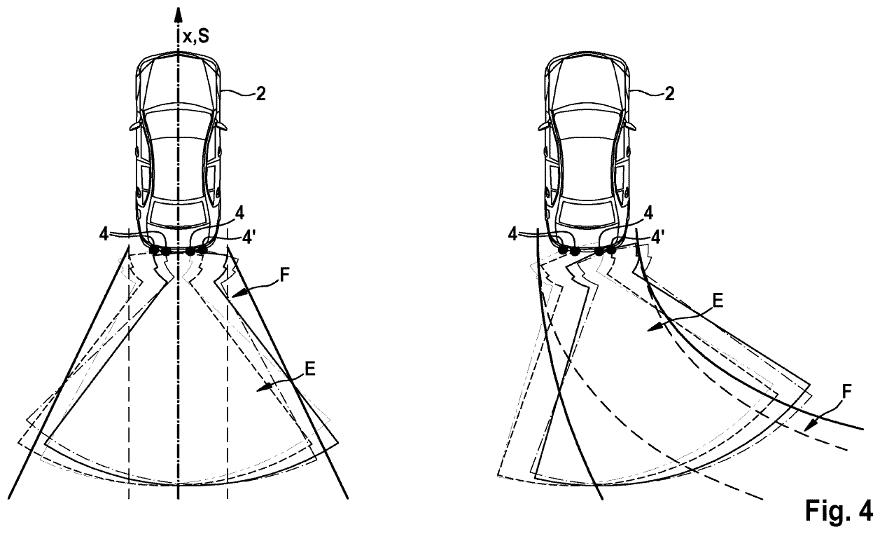

In the vehicle arrangement 1 according to the present invention, the controller 8 can receive measurement data from a unit 10, which can be designed, for example, as a steering angle sensor or as planned trajectory data, in order to determine a direction of travel of the vehicle 2. On the basis of the ascertained direction of travel, the controller 8 generates control commands in order to control the transducer elements 6, 7 with a phase shift P. The controller 8 can dynamically set or vary the phase shift P depending on the ascertained direction of travel. The detection area E can thus be intelligently adjusted to follow a travel route envelope F (see FIG. 4) in order to increase the localization accuracy and the classification in the object recognition.

FIG. 4 shows schematic plan views of a rear area of a vehicle 2 with an adjusted phase angle P when traveling straight ahead (left) and when traveling through curves (right), according to one embodiment of the present invention and illustrates the detection area E being intelligently adjusted to follow the travel route envelope F.

The controller 8 receives drive control data, for example from a unit 10 designed as a steering angle sensor, and thus executes specific control of the calculated route. Here, for example, the same data could be used that uses the expected route with currently turned wheels to display the route section in the infotainment system. However, these data are now used to control each transducer element 6, 7 of the ultrasonic sensor arrays 4 such that the really important area, in particular the travel route envelope F, behind the vehicle 2 is better covered by the detection areas.

For example, the two central ultrasonic sensor arrays 4 can be operated without different phase control, whereas the two outer ultrasonic sensor arrays 4 respectively shift their main visual lobe inward, or in the direction of the axis of symmetry S, as a result of the phase control. The result is that, from a certain distance behind the vehicle 2 in the relevant area F, quadruple coverage is present almost exclusively and a better localization possibility as well as redundancy is thus given.

In the event of a curved movement, as shown on the right in FIG. 4, all ultrasonic sensor arrays 4 can be controlled differently so that the route is ideally “illuminated.”

If, in general operation, the general environment is also to be examined in addition to the relevant area or the travel route envelope F, switching between operating modes for scanning the detection area E without a control of the phase shift P and with a control of the phase shift P can take place.

For example, the phase shift P for a centrally arranged, first ultrasonic sensor array 4 can be set by the controller 8 to deviate from a phase shift P of an ultrasonic sensor array 4′ arranged laterally on the vehicle 2. For the sake of clarity, the controller 8 is shown only in FIGS. 1 to 3.

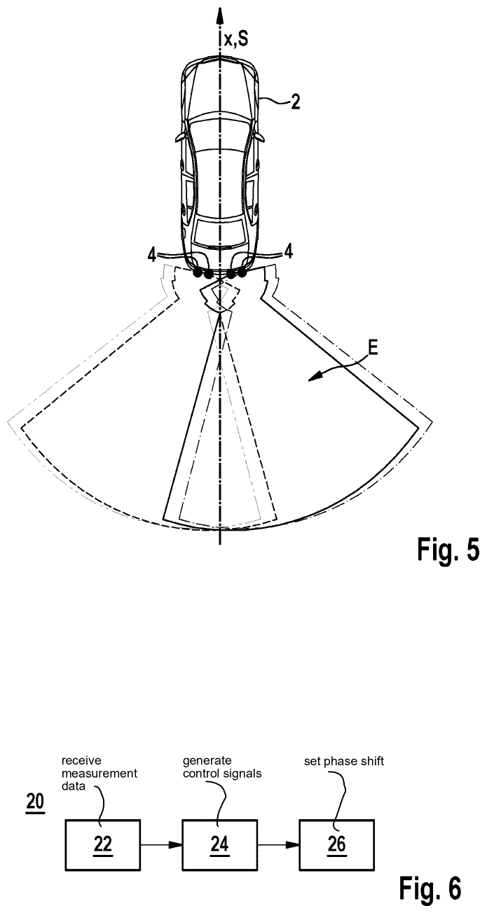

FIG. 5 shows a schematic plan view of a rear area of a vehicle 2 with detection areas E swiveled away from an axis of symmetry S of the vehicle 2, according to one embodiment of the present invention. In this case, a plurality of ultrasonic sensor arrays 4 arranged on the vehicle 2 can be controlled by means of the control commands of the controller 8 such that a “cross-eyed view” of the plurality of ultrasonic sensor arrays 4 is realized so that the detection areas E of the ultrasonic sensor arrays 4 are rotated or deflected toward the vehicle sides. This increases the resulting detection area E of all ultrasonic sensor arrays 4.

Alternatively, concentrating or focusing the detection areas E toward the axis of symmetry S of the vehicle 2 is achieved. The resulting detection area E of all ultrasonic sensor arrays 4 is thus reduced.

Preferably, the axis of symmetry S of the vehicle 2 is an axis that is directed in the longitudinal direction x and passes through a center of the vehicle, in particular between a driver seat and a passenger seat.

FIG. 6 shows a schematic flowchart for illustrating a method 20 according to the present invention, according to one embodiment. The method 20 is used to adjust a detection area E of at least one ultrasonic sensor array 4 of a vehicle 2 by means of a controller 8.

In a step 22, measurement data are received. A direction of travel is ascertained on the basis of the received measurement data.

In a further step 24, control signals for controlling at least two transducer elements 6, 7 of the at least one ultrasonic Sensor array 4 are generated.

A phase shift P between the ultrasonic waves transmitted by the transducer elements 6, 7 and/or a phase shift P between the ultrasonic waves received by the transducer elements 6, 7 is set 26 by means of the control signals, which phase shift is adjusted to the direction of travel of the vehicle 2.

1-15. (canceled)

16. The method for adjusting a detection area of at least one ultrasonic sensor array of a vehicle using a controller, comprising the following steps:
receiving measurement data are received, and ascertaining based on the measurement data, a direction of travel;
generating control signals for controlling at least two transducer elements of the at least one ultrasonic sensor array; and
setting, using the control signals, a phase shift between ultrasonic waves transmitted by the transducer elements and/or a phase shift between ultrasonic waves received by the transducer elements, the phase shift being adjusted based on the direction of travel of the vehicle.

17. The method according to claim 16, wherein the measurement data based on which the direction of travel is ascertained are received from a unit being a parking assistance system, and/or a steering angle sensor, and/or a GNSS sensor, and/or a trajectory planner, and/or a navigation system.

18. The method according to claim 16, wherein the phase shift between the ultrasonic waves transmitted by the transducer elements is set, using the control signals, such that a detection area of the at least one ultrasonic sensor array overlaps a travel route envelope of the vehicle.

19. The method according to claim 18, wherein the travel route envelope of the vehicle is overlapped by the detection area of at least one ultrasonic sensor array in the direction of travel of the vehicle and/or the travel route envelope of the vehicle is overlapped by the detection area of at least one ultrasonic sensor array in a direction opposite the direction of travel of the vehicle.

20. The method according to claim 16, wherein a phase shift between the generated ultrasonic waves of at least two transducer elements arranged offset from one another along a transverse direction and/or along a height direction, is set using the generated control signals, wherein the at least two transducer elements have a distance to one another in a transverse direction and/or in a height direction of at least half a wavelength (lambda) of the generated ultrasonic waves.

21. The method according to claim 16, wherein a phase shift of transducer elements of at least two ultrasonic sensor arrays is set using the generated control signals such that a detection areas of the at least two ultrasonic sensor arrays overlap in an area of the travel route envelope of the vehicle.

22. The method according to claim 16, wherein, when the vehicle drives straight ahead, a detection area of at least one first ultrasonic sensor array and a detection area of at least one second ultrasonic sensor array are concentrated toward an axis of symmetry of the vehicle or are directed away from the axis of symmetry of the vehicle, by a positive phase shift and by a negative phase shift, respectively.

23. The method according to claim 16, wherein the detection area of the at least one ultrasonic sensor array is swiveled according to a steering angle of the vehicle onto a resulting travel route envelope of the vehicle or beyond the travel route envelope in a direction of the steering angle.

24. The method according to claim 16, wherein a phase shift of at least one ultrasonic sensor array of a set of a plurality of ultrasonic sensor arrays is set using the generated control signals.

25. The method according to claim 16, wherein the control signals are generated to apply different phase shifts to at least two ultrasonic sensor arrays.

26. The method according to claim 16, wherein a phase shift between the ultrasonic waves transmitted by the transducer elements that continuously changes along an angular range and is dynamically adjusted to the direction of travel of the vehicle is set using the control signals.

27. The method according to claim 16, wherein an alternating operation is carried out using the control signals, wherein at least one phase shift between the ultrasonic waves transmitted and/or received by the transducer elements is activated and deactivated, wherein a phase shift of 0° is set in the case of a deactivated phase shift.

28. A controller configured to adjust a detection area of at least one ultrasonic sensor array of a vehicle, the controller configured to:
receive measurement data are received, and ascertaining based on the measurement data, a direction of travel;
generate control signals for controlling at least two transducer elements of the at least one ultrasonic sensor array; and
set, using the control signals, a phase shift between ultrasonic waves transmitted by the transducer elements and/or a phase shift between ultrasonic waves received by the transducer elements, the phase shift being adjusted based on the direction of travel of the vehicle.

29. A non-transitory machine-readable storage medium on which is stored a computer program for adjusting a detection area of at least one ultrasonic sensor array of a vehicle using a controller, the computer program, when executed by a computer, causing the computer to perform the following steps:
receiving measurement data are received, and ascertaining based on the measurement data, a direction of travel;
generating control signals for controlling at least two transducer elements of the at least one ultrasonic sensor array; and
setting, using the control signals, a phase shift between ultrasonic waves transmitted by the transducer elements and/or a phase shift between ultrasonic waves received by the transducer elements, the phase shift being adjusted based on the direction of travel of the vehicle.
